(19) United States
(12) Patent Application Publication
(10) Pub. No.: US 2013/0197995 A1
(43) Pub. Date: Aug. 1, 2013

(54) CALL TRACKING SYSTEM AND A METHOD PERFORMED BY A CALL TRACKING SYSTEM

(71) Applicants: Robert Skog, Hasselby (SE); Jan Gabrielsson, Kista (SE)

(72) Inventors: Robert Skog, Hasselby (SE); Jan Gabrielsson, Kista (SE)

(73) Assignee: Telefonaktiebolaget L M Ericsson (publ), Stockholm (SE)

(21) Appl. No.: 13/878,630

(22) PCT Filed: Oct. 21, 2010
(86) PCT No.: PCT/SE10/51135

§ 371 Date: Apr. 10, 2013

(51) Int. Cl. G06Q 30/02

(52) U.S. Cl. CPC G06Q 30/0246
USPC 705/14.45

(57) ABSTRACT

A call-tracking system and a method performed by a call-tracking system is provided where information contained in a trackable message received from a service provider and associated with a first telephone number of a first user equipment addressed to a second user equipment associated with a second telephone number is stored in a database. The message is also forwarded to the second user equipment, and if a trigger message comprising the second telephone number and the first telephone number is received by the call-tracking system, it is determined whether the two telephone numbers of the trigger message correspond to the previously stored telephone numbers stored associated with each other in the database and, whether the call has been made within a predetermined time interval. If the two mentioned conditions are fulfilled, the call is considered to be associated with the advertisement provided to the second user equipment in the message.

### TECHNICAL FIELD

The invention relates to call-tracking system, a method to be performed by a call-tracking, a service provider server, a call-tracking system computer program and a computer program product comprising the call-tracking system computer program.

### BACKGROUND

Different solutions on how to send advertisements, from hereinafter in the description referred to as ‘ads’, in messages, such as e.g. SMS (Short Message Service) or MMS (Multimedia Message Service) messages to UEs (User Equipments) have been proposed. Patent application PCT/EP2009/005390 discloses such a solution.

‘ads’ provided to a UE may include a telephone number associated with an advertiser, which a user can use to dial the advertising party if he chooses to respond to the advertisement. To correlate the display of an advertisement, from hereinafter in the description referred to as ‘ad’, sent to a consumer, and a subsequent telephone call placed by the consumer in response to receiving the ad, the advertiser is typically provided with a specific telephone number dedicated for that particular ad, rather than a commonly used company number. If it can be determined that such a dedicated number is called at a certain volume, it can be concluded that the ad has been successful. There is typically one specific telephone number provided per ad campaign and per advertising channel used for the campaign to be able to distinguish which ad a consumer has, in a positive way, acted upon in case of a response, thereby being able to, for example, assess whether the ad has been successful or not.

A comparison/correlation of data associated with an ad is very important for ad brokers and advertisers in order to help them to evaluate how successful an ad in itself has been and how successful the used ad channel, e.g. the message form in which the ad was exposed on, has been. It also enables performance based advertising models, where advertisers only pay for actions considered to have been generated by, or associated with, a specific ad. Such an action may typically be that a call is made to the telephone number displayed on the ad.

Existing solutions, using so-called call-tracking, require the advertiser to be provided with many campaign specific telephone numbers which will run the risk that customers get confused about which phone number that is the advertiser's “real” phone number. Campaign numbers typically also only lead to the associated business for a limited time period after the ad campaign has finished and customers may have remembered them as the main contact number and even stored them in their phone book for later use. This is not good, neither for the customer, nor for the advertiser.

The company Google today runs call-tracking services where local ads are displayed in conjunction with a map application. Google's solution uses multiple, or specific, numbers provisioned via a service called Google Voice.

U.S. Pat. No. 8,424,442-B2 describes another example of a call-tracking system applying a dynamic allocation of telephone number to an ad on a just-in-time basis; and if the telephone number has not been called for a predefined period of time then the telephone number is unallocated. The disclosed call tracking-system of U.S. Pat. No. 8,424,442-B2 is designed for advertisement via web pages.

### SUMMARY

An object of the present document is to address at least some of the problems mentioned above. More specifically, an object of the document is to provide a call-tracking system for a message service, such as SMS or MMS, where no temporary telephone number associated with a certain advertisement has to be provided by the call-tracking system in order to be able to estimate the successfulness of the advertisement, by determining whether or not the distribution of a message leads to that the recipient makes a call to the party who initiated the distribution of the message.

According to a first aspect, a method performed by a call-tracking system is provided, which is initiated when a message associated with a first telephone number of a first user equipment addressed to a second user equipment associated with a second telephone number is received from a service provider. The message comprises an advertisement, the first telephone number, the second telephone number and a service provider indicator, identifying the service provider.

Next it is determined whether or not the message is a message that is trackable by the call-tracking system and, in case the message is found to be a trackable message, the first telephone number, the second telephone number, a time associated with the transmission of the message from the call-tracking system to the second user equipment, and the service provider indicator are stored associated with each other in a database.

In addition to storing the content of the message, as listed above, the message is forwarded to the second user equipment in a conventional message forwarding manner. When, at a later time instance, a trigger message, comprising the second telephone number and the first telephone number, indicating the initiation of a call originating from the second telephone number and terminating at the first telephone number, is received from a proxy server, it is determined whether the two telephone numbers of the trigger message correspond to the telephone numbers stored associated with each other in the database; and whether the call has been made within a predetermined time interval, indicating a time duration that has elapsed from the forwarding of the message from the call-tracking system to the second user equipment and the making of the call, wherein the call is considered to be associated with the message, in case the two number pairs correspond to each other and the call has been made within the predetermined time interval.

Accordingly, the method makes it possible to, on a per call basis, determine whether the making of a trackable call can be considered to have been triggered by the transmission of a message promoting such a call, without requiring the caller to use a telephone number other that a conventional company number.

The suggested call-tracking system is an automatically triggered and executed system, which does not require any interaction, from the initiator of the message, nor does it require any interaction from the recipient, other then the recipient making a telephone call in response to receiving a message.

Another advantage with being able to use a conventional company number also when responding to a message, which may be associated with a time limited campaign, is that the caller will be able to use a telephone number which is well established and well known to a large group of customers, rather then a temporary telephone number, which may be difficult to associate with the specific company.

According to one embodiment, advertisement information indicative of a call originating at the A-number and terminating at the B-number is stored if the two number pairs correspond to each other and if a call involving the matching number pairs has been made within a predefined time interval. Thereby, information indicative of the activity triggered by a specific commercial or information activity can at a later stage be evaluated on the basis of such accumulated information. In addition to storing the information mentioned above, also an indication of the length of the call may be comprised in the advertisement information to be stored, thereby enabling for collection of statistics on the length of the calls make in association with receiving a specific message from the A-number.

Alternatively, or in combination with storing the advertisement information, at least some of the advertisement information may be transmitted to the service provider e.g. for storage and later retrieval and data processing.

The first telephone number may e.g. be provided to the call-tracking system via an Application Programming Interface, which may typically be any of a Short Message Peer to Peer Application Programming Interface or a MM7 Application Programming Interface.

According to one embodiment, the step of determining whether the message is a trackable message may be performed by interrogating an information header of the message, and by determining that the message is a trackable message, in case the information header contains such an indication.

In addition, the message may comprise an advertisement identity, identifying the advertisement contained in the massage, which advertisement identity is stored in the database together with the associated second telephone number, the first telephone number, the time of transmission of the message from the call-tracking system to the second user equipment, and the service provider indicator.

The call-tracking system described above may comprise a Short Message Service Center (SMS-C), wherein the message is an SMS, or a Multimedia Message Service Center (MMS-C), wherein the message is an MMS.

Alternatively, the call-tracking system may also comprise a Service Control Point (SCP).

The trigger message may e.g. be an Intelligent Network (IN) trigger.

According to one embodiment, the service provider indicator is a Uniform Resource Locator (URL) associated with the service provider, which provides for later easy identification of a specific service.

According to another aspect, a call-tracking system suitable to perform the method described above is suggested. The call tracking system comprises a first receiving means, configured to receive a message associated with the first telephone number of a first user equipment, addressed to a second user equipment, associated with the second telephone number, from a service provider, where the message comprises an advertisement, the first telephone number, the second telephone number and a service provider indicator, identifying the service provider from which the message is sent.

The call-tracking system also comprises first determining means, configured to determine whether the message is a message that is trackable by the call-tracking system and storing means configured to store, associated with each other in a database: the first telephone number; the second telephone number; a time associated with the transmission of the message from the call-tracking system to the second user equipment, and the service provider indicator, in case it is found that the message is a trackable message.

In addition to performing call-tracking activities, the call-tracking system also comprises a forwarding means, configured to forward the message to the second user equipment, in any conventional message forwarding manner.

When a trigger message, comprising the second telephone number and the first telephone number, and indicating the initiation of a call originating from the second telephone number and terminating at the first telephone number, is received by a second receiving means, a second determining means is configured to determine whether the two telephone numbers of the trigger message correspond to the telephone numbers stored associated with each other in the database, and, to determine whether the call has been made within a predetermined time difference, indicating the time duration that has elapsed from the forwarding of the message from the call-tracking system to the second user equipment and the making of the call. If both conditions mentioned above are fulfilled, i.e. the two number pairs correspond to each other and the call has been made within the predefined time interval, the call is considered to be associated with the message.

The call tracking system described above may also comprise a call indicator, configured to store advertisement information indicative of a call originating at the A-number and terminating at the B-number if the two number pairs correspond and if a call involving the matching number pairs has been made within the suggested time interval, i.e. if a call associated with a message sent from the B-number to the A-number has been registered.

In addition, the call-tracking system may comprise a report generator, configured to provide a report to the service provider by transmitting at least a part of the advertisement information to the service provider. In addition to storing the advertisement information mentioned above, the report generator may be configured to store, as part of the ad information, also an indication of the length of the call. Such an indication may be obtained by using any type of conventional call measuring technique.

The call tracking system may also comprise first receiving means which is configured to identify the first telephone number when provided via an Application Programming Interface. More specifically, the first determining means may be configured to interrogate an information header of the message, and to determine that the message is a trackable message in case the information header contains such an indication.

The call-tracking system may be a SMS-C or a MMS-C. Alternatively, the call-tracking system may be a SCP.

According to yet another aspect, a service provider adapted for communication with the described call-tracking system is provided. According to one embodiment, the service provider comprises message means, configured to create and send a message to the call tracking system, and to insert a header into the message, indicating to the call-tracking system that the message is a trackable message.

According to another aspect, a call tracking system computer program is provided, where the call tracking system computer program comprises computer readable code means which when run on a node of the call tracking system causes the node to receive a message from a service provider, which message is associated with a first telephone number of a first user equipment, addressed to a second user equipment, associated with a second telephone number, wherein the message comprises an advertisement, the first telephone number, the second telephone number and a service provider indicator, identifying the service provider.

In addition, the computer readable code means also causes the node to determine whether the message is a message that is trackable by the call-tracking system and to store, associated with each other in a database, the first telephone number; the second telephone number; a time associated with the transmission of the message from the call tracking system to the second user equipment, and the service provider indicator, in case the message is found to be a trackable message.

The computer readable code means also causes the node to forward the message to the second user equipment; to receive a trigger message comprising the second telephone number and the first telephone number from a proxy server, where the trigger message is indicating the initiation of a call originating from the second telephone number and terminating at the first telephone number; to determine whether the two telephone numbers of the trigger message correspond to the telephone numbers stored associated with each other in the database and to determine whether the call has been made within a predetermined time difference, indicating the time duration that has elapsed from the forwarding of the message from call-tracking system.

In case it is found that the two number pairs correspond to each other and that the call has been made within the time interval, the call is considered to be a call associated with the message.

When run on a node of the call tracking system, the computer readable code means may be configured to cause the node to store advertisement information indicative of a call originating at the A-number and terminating at the B-number, in case the two number pairs correspond and a call involving the matching number pairs has been made within the mentioned time interval, i.e. if the call has been considered to be associated with the message.

According to yet another embodiment, the computer readable code means may also be configured to cause the node to transmit at least part of the advertisement information to the service provider, thereby enabling for the service provider to collect information on a commercial or information activity associated with a respective message and to provide statistics on such an activity. In addition to comprise one or more of the data items previously stored by the call-tracking system in association with reception of a respective message, also the length of the call may be contained in the advertisement information and stored together with the remaining data items.

In addition, the computer readable code means may also be configured to select trackable messages from messages received from the service provider by causing the node to interrogate an information header of a received message, and to determine that the message is a trackable message in case the information header contains such an indication. In addition, the computer readable code means may be configured to cause the node to store an advertisement identity, identifying the advertisement in the database together with the associated first telephone number, the second telephone number, a time associate with the transmission of the message from the call-tracking system to the second user equipment, and a service provider indicator, identifying the service provider, in case it is found that the message is a trackable message.

### BRIEF DESCRIPTION OF THE DRAWINGS

The objects, advantages and effects, as well as features of the invention, will be more readily understood from the following detailed description of exemplary embodiments of the invention when read together with the accompanying drawings, in which:

FIG. 1 illustrates network nodes and some initial steps for performing call-tracking according to one embodiment.

FIG. 2 is a flow chart illustrating a call-tracking method executable by a call-tracking system implemented in a network node according to the embodiment described in FIG. 1.

FIG. 3 illustrates network nodes and some initial steps for performing call-tracking according to a second embodiment.

FIG. 4 is a flow chart illustrating a call-tracking method executable by a call-tracking system implemented in network nodes according to the embodiment described in FIG. 3.

FIG. 5 is a flow chart illustrating a call-tracking method which is applicable for both embodiments described above.

FIG. 6 schematically illustrates a call-tracking system implemented on one network node, according to a first embodiment.

FIG. 7 schematically illustrates a distributed call-tracking system according to a second embodiment

FIG. 8 schematically illustrates a call-tracking system according to FIG. 6 according to one embodiment.

FIG. 9 schematically illustrates a distributed call-tracking system according to a second embodiment.

FIG. 10 schematically illustrates a service provider server configured to operate in cooperation with a call-tracking system.

FIG. 11 schematically illustrates the service provider server of FIG. 10.

### DETAILED DESCRIPTION

While the invention covers various modifications and alternative constructions of a call-tracking system and a method to be performed by such a system, different embodiments of the invention are shown in the drawings and will hereinafter be described in detail. However it is to be understood that the specific description and drawings are not intended to limit the invention to the specific forms disclosed. On the contrary, it is intended that the scope of the claimed invention includes all modifications and alternative constructions thereof falling within the spirit and scope of the invention as expressed in the appended claims. It is also to be understood that the naming of the described means and modules are not restricted to the naming suggested in this document, but merely intended to be considered as examples, where the names may have been chosen for a better understanding of the suggested call-tracking system and associated method.

The invention, hereinafter described as some alternative embodiments, allows the comparison, or correlation, of a main phone number sent in a message, such as e.g. an SMS, MMS, or as any type of image or audio/video file included in an MMS, displayed by a UE and used in a subsequent telephone call placed by the same UE, to the phone number of the caller of the subsequent call. The main phone number shall here be interpreted as the telephone number used by a company on a permanent basis i.e. not a temporary telephone number created for the sole purpose of tracking a specific message, associated with a certain activity, but a telephone number that can be reused by and well established among customers over time. By applying the suggested call-tracking method, a telecommunications network operator may be able to run such a service as a value added service for an ad broker, allowing the operator to easily track the level of success of a respective ad in question.

The given example is describing how one message and a possible call associated with the message may be registered by a call-tracking system. However, in a typical scenario, a plurality of messages associated with a certain activity are distributed to a plurality of recipients. By storing and processing accumulated information associated with such an activity, the outcome of the activity, i.e. the grade of success from distributing the message, may be evaluated in a simple and straightforward manner.

As will be described in further detail below, the call-tracking system may according to a first embodiment be implemented in a SMS-C, or a MMS-C, depending on what type of messages that is to be used for distribution of an advertisement. Alternatively, the call-tracking system may be implemented in an SCP which is configured to interact with a SMS-C or an MMS-C.

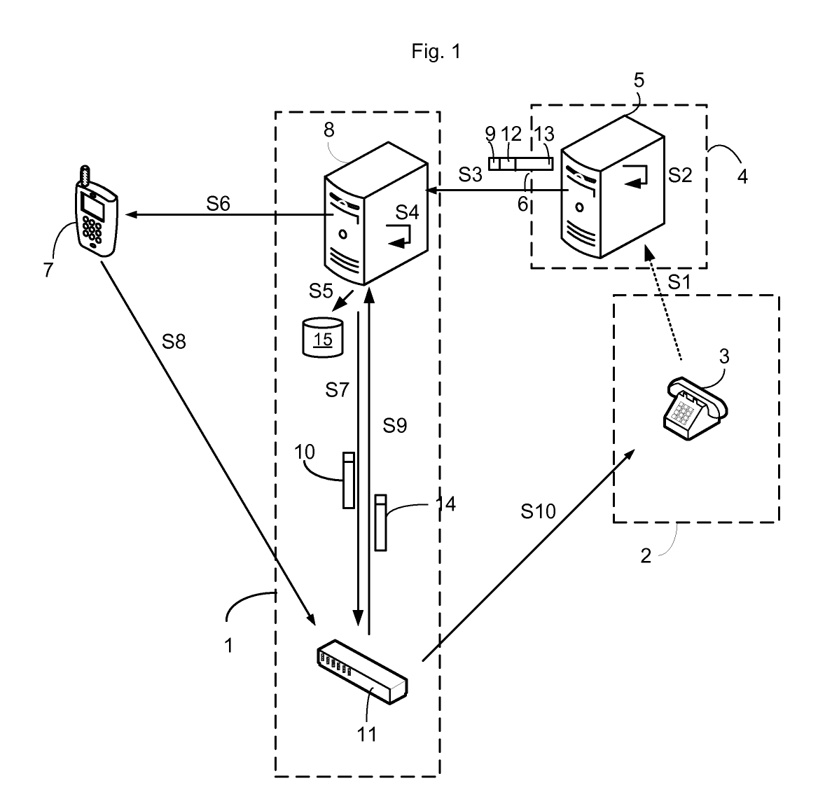

FIG. 1 shows a first embodiment of the invention, which discloses a technical implementation for a telecommunications network operator 1 to take part in an SMS or MMS advertising value chain, such as the one mentioned above, without having to set up a system where temporary campaign telephone numbers have to be generated for an advertiser 2. The advertiser 2 is typically a company that wants to inform users about a product or a service that they want to sell, but can alternatively be a charity or a non-profit organization which uses the described service for distribution of information, where the grade of success of the distribution can be tracked. The advertiser 2 is in contact with a Service Provider (SP) 4, comprising a SP server 5, in the present case via a telephone 3, from hereinafter referred to as a first UE, located on the advertiser-side.

As indicated with a dashed arrow S1 in FIG. 1, the advertiser 2 supplies information to the SP 4, comprising at least a first telephone number, from hereinafter referred to as B-number, of the advertiser 2, which telephone number is typically being used as a permanent telephone number by the advertiser 2, together with some ad content, describing the ad that the advertised 2 wants to distribute via the SP 4. Even though a telephone is used in the described example, it is to be understood that any other type of communication means, such as e.g. a mobile phone, a laptop or a PC, via which the ad content can be provided to the SP 4 together with a B-number may be used as communication means.

The SP 4 is responsible to the advertiser 2 to arrange the ad content into an appropriate format and to distribute the ad and/or make the ad, or a link to the ad, visible to a recipient in a message 5, which in the embodiments presented in this document is exemplified with an SMS or an MMS message. The ad could be arranged as the whole part of a displayed part of the SMS or MMS message, once displayed on a display on or under the control of a second UE 7, which comprises an SMS or an MMS client (not shown) depending on the type of message received. Alternatively the ad could be an along-side ad accessible via an original SMS or MMS message.

The second UE 7 may be provided with a secure element in the form of e.g. a SIM (Subscriber Identity Module), ISIM (Internet Protocol Multimedia Services Identity Module) or USIM (Universal Subscriber Identity Module), and may typically be a mobile phone, a PDA (Personal Digital Assistant) a PC or a laptop accessible via a wired or wireless access network (not shown) of a telecommunications network by a network node, typically a SMS-C or MMS-C, or any another type of corresponding node which is capable of providing an SMS or an MMS to a UE 7, which typically is located in, or connected to a WAN (Wide Area Network), such as e.g. the Internet. From hereinafter the SMS-C or MMS-C will be referred to as a message center 8, which, in addition to being able to operate as a conventional SMS-C or MMS-C is also configured to perform call-tracking of incoming messages in a way which will be described in further detail below. Consequently, message center 8 comprises an SMS-C or an MMS-C which is configured to also operate as a call-tracking system either as a stand-alone entity or when interacting with another functional entity, comprised in the call-tracking system.

According to the first embodiment, described with reference to FIG. 1, messages transmitted between the SP server 5 and the second UE 7 have to pass the call-tracking system at least partly comprised in the message center 8, as will be explained more in detail in conjunction with the method steps illustrated with arrows S1-S10 of FIG. 1.

The SP server 5 may e.g. be an ESME (External Short Messaging Entity) host communicating with an SMS-C over an SMPP API (Short Message Peer-to-peer Protocol Application Programming Interface), or with an MMS-C over an MM7 API.

In a first step S1, of FIG. 1, an advertiser uses the first UE 3 to provide the ad content and the B-number to a SP server 5.

In a second step S2, a message 6, which may be an SMS, an MMS or any other corresponding type of message, comprising an ad, which is based on the ad content provided to the SP server 5 in step S1, is generated together with a B-number provided together with the ad content. In FIG. 1 the message 6 is described as comprising a header 12 and user information 13, where the user information comprise at least the ad content and the B-number mentioned above. This step may also comprise the insertion of an indicator, which may be referred to as a trace indicator, into an additional header of the message 6, here referred to as an information header 9. In one embodiment, this information header 9 comprises a trace indicator which is configured such that it can indicate e.g. “x-trackable: true”, in case the respective message is trackable, but the applied trace indicator may of course be defined such that it indicates traceability in any other way agreed upon in advance by the telecommunications network operator 1 and the SP 4.

In a third step S3, the message 6 is transmitted to the message center 8, and in a fourth step S4 it is determined at the message center 8 whether the received message 6 is a trackable message or not. If, as described above, a track indicator is contained in the message, the trackability is determined by interrogating the respective information header 9 of message 6. Alternatively, this determination may be based on a predetermined selection criteria, e.g. such that all messages sent to an A-number of a certain geographical area are considered trackable by the message center 8. In yet another scenario, all messages received from the SP server 5 by the message center 8 may be considered trackable, i.e. no selection is required at all.

In a fifth step S5 content of a message 6 which has been found to be trackable is stored in a database 15, configured as a correlation database, which may be comprised in a memory, e.g. in the form of a RAM or a Flash memory. It is for the embodiments disclosed in the detailed description proposed an extensive use of RAM:s as the hosting memory for the database 15, and the parameters should therefore naturally be stored in a way suitable for such a memory. However a person skilled in the art would acknowledge that the parameters could be stored associated with each other in several different ways known to a person skilled in the art, such as storing the parameters in different fields of the same record in a flat, table model database, or in a relational database.

The content to be stored at this stage comprise at least the first telephone number (B-number), the second telephone number (A-number), and a service provider indicator (sp_ind). The service provider indicator mentioned above may disclose any type of information which makes it possible to identify or find the SP 4 and may be e.g. an IP-address, an identity written in plain text or a URI (Uniform Resource Identifier) in the form of a URN (Uniform Resource Name) or a URL (Uniform Resource Locator). Taking the URL as an example, it can automatically be retrieved by the message center 8 already by looking for a host name in the message 6 received from the SP server 5.

In addition, a time value, here referred to as t_send, associated with the forwarding of the message 6 from the message center 8 to the second UE 7, is determined and stored together with the mentioned data. t_send can be retrieved by applying a conventional mechanism, such as e.g. by applying a time stamping or time checking function in the message center 8 according to any message time stamping method known to a person skilled in the art. A method that utilizes a CPU counter or any method where a time is requested from another node in response to recognizing the occurrence of a certain event, in this case the transmission of a message from the message center 8, may e.g. be applied. In such embodiments it is appropriate to log and store the approximate time value when the message was received by the message center 8, or when the message was forwarded to the second UE 7.

In another embodiment, t_send, is instead indicative of the time the message 6 is sent from the SP server 5 and may be added to the message 6 by the SP server 5. It should be obvious from the embodiments above that the intention of the time associated with the forwarding of the message 6 to the second UE 7 is not only limited to the exact time when the message 6 is actually forwarded. It is generally sufficient for the purpose of this invention that the time deviation between the actual forwarding and the assessed time is as long as 1 minute, although this process generally requires a much shorter time, of course in dependence of the size of the message 6 in question.

In association with storing the required content, the message center 8 forwards the massage to the second UE 7, as indicated in a sixth step S6, by applying any type of conventional forwarding techniques.

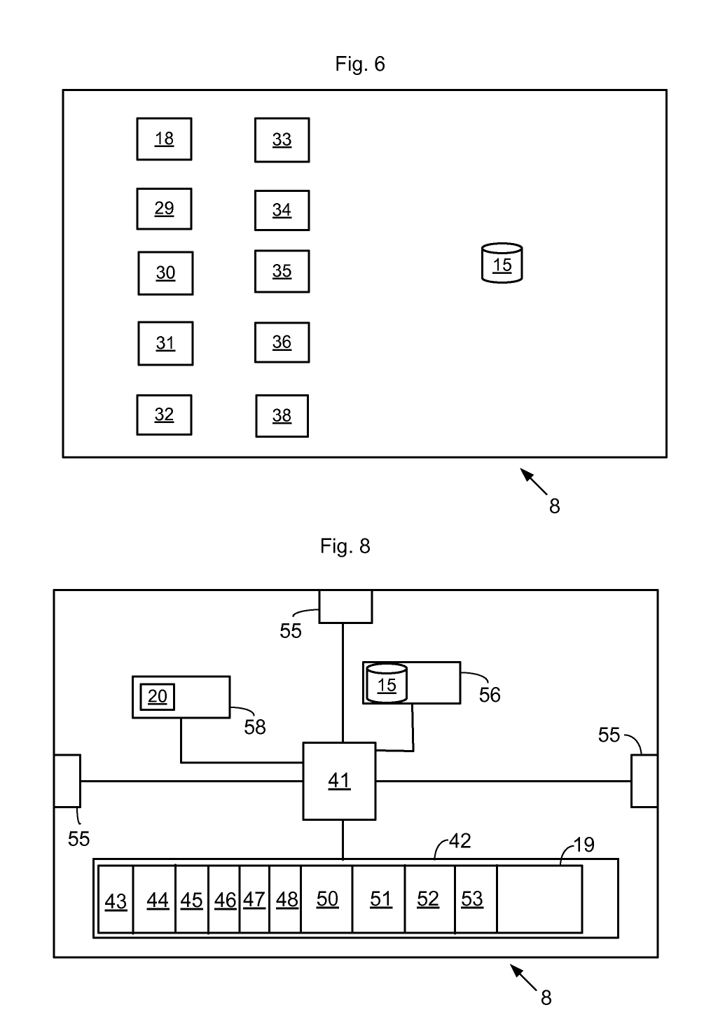

In an optional seventh step S7, a notifier 18 (see FIG. 6) comprised in the message center 8 causes the message center 8 to send a notification 10 to a proxy server 11. The notification 10 comprises in one embodiment of this seventh step S7 the A-number and the purpose of such a notification is to notify the proxy server 11 that a trigger message 14 shall be sent from the proxy server 11 to the message center 8 if the second UE 7 makes a call via the proxy server 11.

In another embodiment of the seventh step S7, the B-number is comprised in the notification 10, indicating to the proxy server 11 that every call to the B-number shall initiate a trigger message 14. As will become obvious further down, this seventh step S7 is intended to decrease the communication between the proxy server 11 and the message center 8, such that only calls of interest to the message center 8 results in a trigger message 14 being sent from the proxy server 11 to the message center 8. The notification can e.g. be an SS7 (Signaling System 7) message.

When a user of the second UE 7 has received the message 6 he can look at the ad, e.g. via a display of the second UE 7, identify the B-number of the ad and determine whether or not to respond to the ad. Here we assume that after a while the second UE 7 responds to the ad by making a call to the B-number. This is indicated as an eights step S8 in FIG. 1. In case of making a call to a fixed UE, as indicated in FIG. 1, the call is typically being transmitted via the proxy server 11 between a PLMN (Public Land Mobile Network) associated with the second UE 7 and a PSTN (Public Switched Telephone Network) to which the first UE 3 associated with the B-number is connected. In other words, in the given example, the second UE 7 makes a circuit call to the B-number via the proxy server 11, which for example can be an MSC (Mobile Switching Center) for a GSM (Global System for Mobile communications) or UMTS (Universal Mobile Telecommunications System) network.

For the purpose of this invention the proxy server 11 comprises a function for sending the trigger message 14, comprising the A-number and the B-number, to the message center 8 in response to a call set up between the A-number and the B-number, originating at the A-number. This function is in the present embodiment typically executed by a SSF (Service Switching Function) for IN communication with the message center 8 based on SS7, according to procedures which are known as such. Another term used in the art for the SSF is SSP (Service Switching Point), but SSF will be used hereinafter.

In a ninth step S9, the SSF causes the proxy server 11 to send the trigger message 14, typically in the form of an IN-trigger comprising the A-number and B-number, to the message center 8 when the second UE 7 calls the first UE 3, but in other embodiments a type of trigger message format other than SS7 may be applied. As will become obvious further down, the applied trigger may also comprise a time value, t_rec, indicative of when the call was received by the proxy server 11. As discussed above, a trigger message could be sent for all calls routed via the proxy server 11, but in order to reduce network load, the proxy server 11 could preferably be provided with information from the message center 8 in order to only send a trigger message in some specific cases, such as when the second UE 7 call somebody, or when somebody calls a UE, such as the first UE 3, associated with the B-number. The proxy server 11 could in an alternative embodiment be configured to only send the trigger message 14 when the A-number is used for calling the B-number, but that requires the notification 10 to comprise both the A-number and the B-number.

In a tenth step S10 the proxy server 11 enables the call to be forwarded to the B-number in a conventional manner. The tenth step S10 may naturally be performed before or at the same time as the ninth step S9, or more specifically, any time subsequent to step S8.

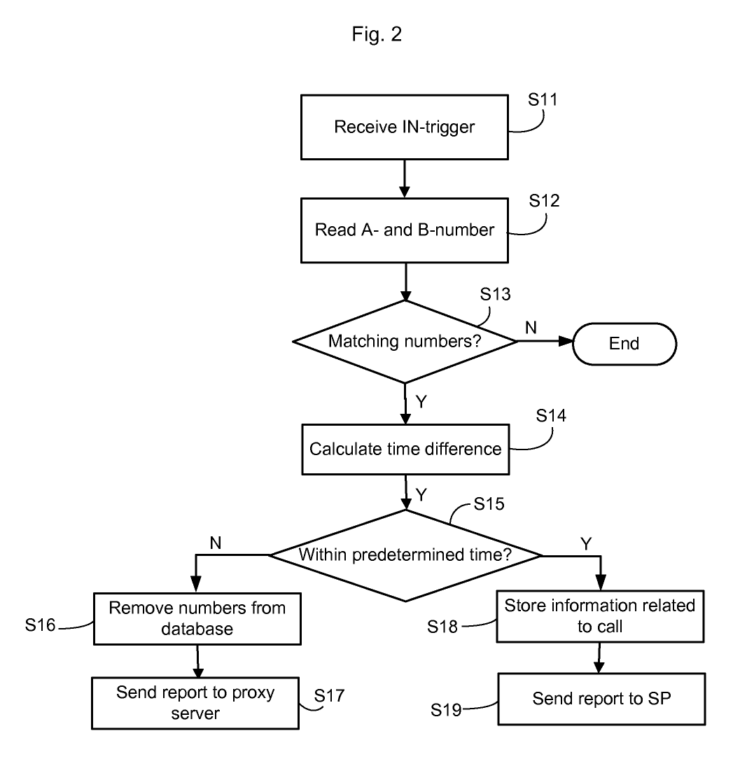

In an eleventh step S11, which together with the subsequent steps is illustrated in FIG. 2, the method continues by the message center 8 receiving the trigger, which in the present example is an IN-trigger, from the proxy server 11.

In a twelfth step S12 a first application, which may typically be an IN application in case the trigger was an IN-trigger, in the form of a message center computer program 19 (see FIG. 8) installed and run by the message center 8 causes the message center 8 to read the A-number and the B-number contained in the IN-trigger.

In a thirteenth step S13 the IN application causes the message center 8 to compare the number-pair, i.e. the two received telephone numbers in the IN-trigger, with number-pairs already stored in the database 15. If a matching pair is found in the database 15, the application causes the message center 8 to continue with executing a fourteenth step S14 where a time difference, t_diff, is calculated between the time indicative of when the call was made by the second UE 7 and the time, t_send associated with the transmission of the message 6 from the call-tracking system to the second UE 7. As stated above, the time indicative of when the call was made can be retrieved from the IN-trigger. The time, t_trigger, comprised in the IN-trigger can as such be defined as the time when the call was received or forwarded by the proxy server 11 or the time when the IN-trigger was sent from the proxy server 11. Furthermore, t_trigger may not have to be sent in the IN-trigger, but may alternatively be set to the time value when the IN-trigger is received by the message center 8. In other words the actual, exact point of time when the call was placed does not have to be used. It is sufficient that the time associated with the time when the call was made is accurate enough for the object of the invention to be fulfilled.

In a fifteenth step S15 the time difference, t_diff, is compared with at least one predetermined time value 20 (see FIG. 8). In the embodiment disclosed in conjunction with FIG. 2 there is only one predefined time value 20, and it is here generally a question of whether t_diff is below or above this time value 20. If t_diff is above time value 20, the call is being deemed as not being related to the ad, i.e. a to long time interval has elapsed since the reception by the second user of the message. In such a case the message center 8 may just end the processing associated with the trigger. If it is found in the fifteenth step S15 that t_diff is larger than time value 20, then the application causes the message center 8 in a sixteenth step S16 to remove the record comprising the respective number-pair and the associated t_send and SP indicator from database 15 in order to avoid the execution of steps S14 and S15 in the future. The sixteenth step S16 may also initiate the sending of a second notification from the message center 8 to the proxy server 11, as indicated in a seventeenth step, S17 for the purpose of notifying the proxy server 11 that trigger messages does not have to be sent any more with respect to at least one of the telephone numbers, e.g. the A-number, of the respective number pair. The actual content of the optional second notification of course will depend on the embodiments discussed in the seventh step S7 and the ninth step S9.

Even if there is only one time value 20 defined in the exemplary fifteenth step S15 above, there may in other embodiments be several different time values defined with which the time difference can be compared in order to determine a certain time interval, t_diff, in which the call can bee made and still be considered to be associated with a specific message.

If the answer is instead ‘yes’ in the fifteenth step S15, i.e. t_diff is smaller than the time value 20, the call is considered as being an action initiated by the ad shown to the user of the second UE 7 or, in the present case, the call is considered as associated with the message forwarded to the second UE 7. Typically, as a result of a successfully registered call, information, which may be referred to as ad information, is stored for later retrieval or reporting. Therefore, in an eighteenth step S18, the message center 8 stores information related to the call by logging the call as being ‘successful’, i.e. being a call related to the ad from the user of the B-number, in a database. In FIG. 1, the database 15 is hosted by the message center 8, but may of course alternatively be hosted by another device or node connected to the message center 8. The actual design of the database 15 and what further information that is suitable in the log records associated with a specific message other than B-numbers and an indicator of one or more successful calls related to the B-numbers may of course be done in numerous ways depending on what kind of information the SP 4 desires from the message center 8. However, one way of designing the database 15, is to store a record with ad information comprising at least a B-number and a counter value, nr of calls, which counter value shows how many successful calls that have been made to the B-number.

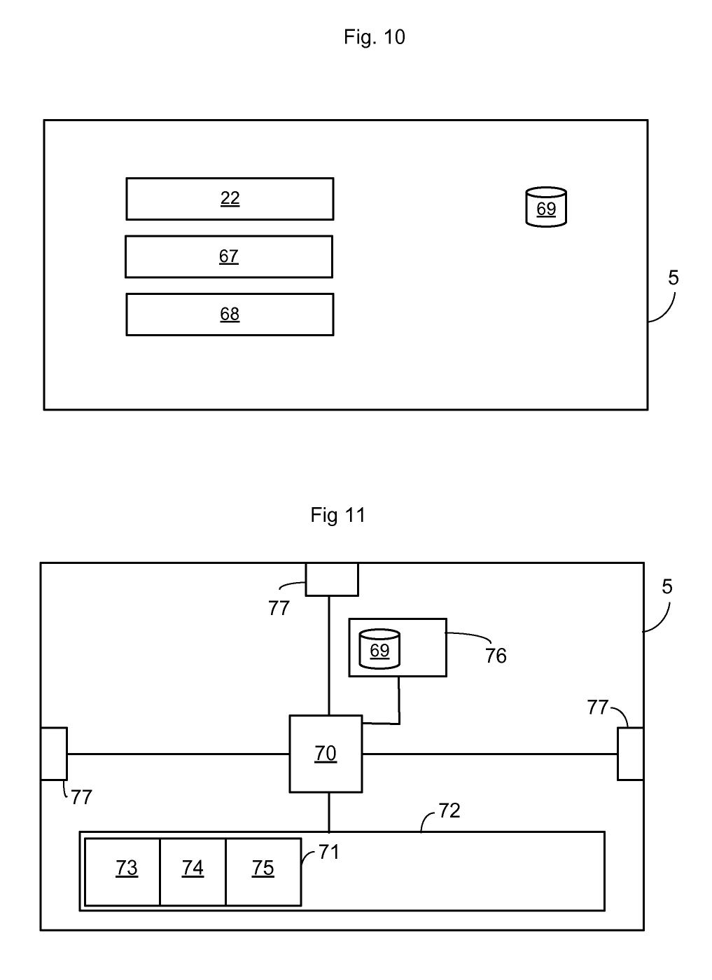

Upon request from the SP 4, the message center 8 may just return a counter value associated with the B-number in the database 15. A more sophisticated logging of successful calls may comprise storing of record fields in the database 15 for ad information comprising the A-number, the time when the call was made, or when a trigger was sent by the proxy server 11, i.e. t_trigger, or received by the message center 8, the length of the call, call_length, and an indicator, call_response, showing that the advertiser really answered the call, or that the second UE 7 returned a busy signal or that the advertiser 2 was unable to answer the call. Such a more sophisticated logging naturally requires more messages to be sent between the proxy server 11 and the first application in the message center 8. The SP server 5 may for the purpose of receiving reports comprise report requesting means 22 (see FIG. 10) which, for example, may be configured such that, at regular time intervals, it requests statistical reports associated with a certain ad, provided from the message center 8 via a certain message, via at least one B-number associated with the ad. A report sent, as illustrated in FIG. 2, as a nineteenth step S19, from the message center 8 to the SP server 5 can thereby e.g. be used as a basis for the owner of the message center 8 to charge the SP 4 in dependence of a business agreement and for the SP 4 to charge the advertiser 2 according to another business agreement dependent on how successful the ad via the channel provided by the SP 4 has been. The actual business agreements/charging models used are out of the scope of this invention, but they could of course be of any known kind where the output of the database 15 to the SP 4 is appropriate, e.g. charging being directly proportional to the number of successful calls. In a case where there are multiple time values to compare with in the fifteenth step S15, the business agreement between the SP 4 and advertiser 2 could e.g. be to pay one fee for every call made within a certain, first time value, and a reduced fee for every call made within a second, larger time value.

Reporting on successful calls may typically be made instantaneously via the message center 8 or at a later point of time, e.g. where a report provided to the SP server 5 comprises information which has been assembled in batches for each B-number separately, or for more than one B-number. If a SP 4 can provide information to an advertiser, indicating e.g. that, within five minutes after the A-number has received a message from the B-number, a call from the A-number to the B-number has been placed, it is very likely that the user of the A-number was presented to the B-number via the message. If the call is placed after a longer time, i.e. a time exceeding the time value 20 mentioned in conjunction with the fifteenth step S15 above, the caller can be deemed to have seen the B-number in some other place, before making the call.

It should be noted that the insertion of the information header 9 in step S2 is not a mandatory step according to the invention. The information header 9 and the track indicator therein do not have to be linked to any of the other steps performed in the steps discussed in conjunction with FIGS. 1 and 2. Another way of using the track indicator is to use it to alert the SP 4 that an ad for which call-tracking could be used, has been sent to a potential customer of the advertiser 2, thus initiating the SP 4 to request a report from the owner of the message center 8 in a manual or automatic way at a later point of time. The track indicator even makes it possible for the SP 4 to assemble its own reports independently of the reports from the owner of the message center 8.

It is also realized that the advertiser 2 may provide the SP 4 with more than one ad, where all the provided ads comprise the same B-numbers. In such a situation the advertiser 2 may be interested in distinguishing which ones of the provided ads which were more successful than others. In order to solve this problem, an as identity, ad_Id, of each ad can be used and logged in the following manner. In the embodiment of the second step S2 where an information header 9 is added, the SP server 4 also includes into the information header 9 an ad identity, of the ad related to the B-number shown in the ad. The ad identity could be any kind of identity which enables the SP 4 to identify the ad. In other words it could just be a number set by the SP 4 and inserted in the new information header 9, such as e.g. “x-adid:0000003”, or something more indicative of the advertiser 2, such as “x-adid:advertiser7-000001”. The ad identity could not only be set by the SP 4, but could e.g. be a reference number, originally received from the advertiser 2 in order to facilitate subsequent communication, e.g. business related discussions, between the advertiser 2 and the SP 4 about the ad. For such a purpose the ad identity could also comprise two references, being both a reference of the SP 4 and a reference of the advertiser 2. Accordingly, also the ad identity in the information header 9 is retrieved and stored associated with the other stored parameters in database 15 by the message center 8. Furthermore the ad identity is stored by the message center 8 in the eighteenth step S18 in the same database 15 as the other information stored therein in this step. Moreover the ad identity may suitably be included in a report sent to the SP 4 in the nineteenth step S19, thereby enabling assessment not only of successful calls based on ads from a particular advertiser, but also the level of success of different ads for the advertiser 2. Although the information header 9 has been mentioned as the carrier of the ad identity in message 6, the ad identity may alternatively be comprised in a new, second header 12 of the message 6.

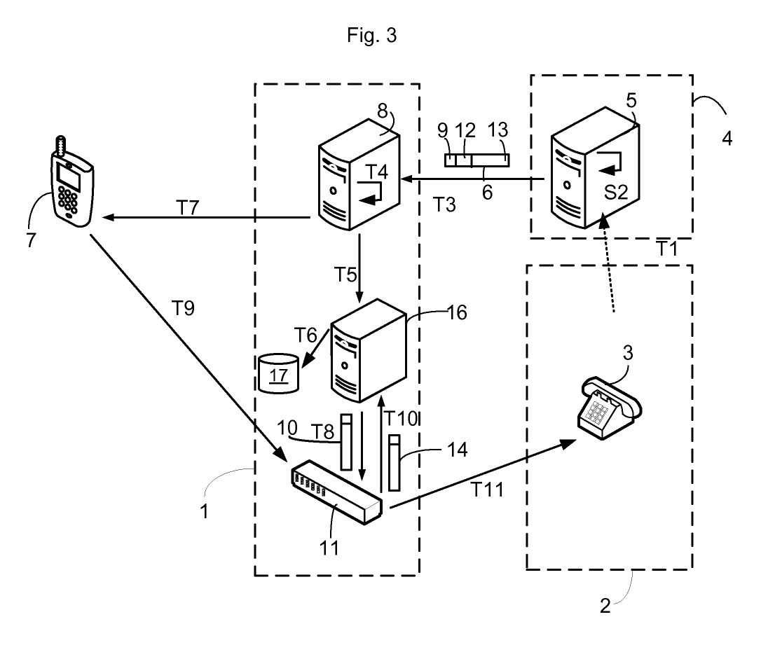

FIG. 3 describes a call-tracking system according to a second embodiment having many similarities with the first embodiment described above, including all alternatives described above which the person skilled in the art would realize fits well also with the second embodiment. The steps S1-S4 of FIG. 3 corresponds to steps T1-T4 of FIG. 1. The difference between the two embodiments is, node-wise, that according to known IN-architecture, an SCP (Service Control Point) 16 is introduced between the proxy server 11 and the message center 8 and, thus, in addition to comprising a message center 8, which in the present case is a SMS-C or a MMS-C, the call-tracking system also comprises a SCP 16. The SCP 16 is known as a node as such for a person skilled in the art of IN and is therefore not described more in detail with respect to all features of the SCP that are already known.

FIG. 3 also illustrates steps made in the embodiment of FIG. 3, after the fourth step T4 has been performed. Here, in a fifth step T5, the message center 8, having determined in step T4 that the received message is trackable, sends an instruction to the SCP 16, instructing it to track the message. The instruction comprises the A-number, B-number and a time, t_send, retrieved by the message center 8 in the third step S3. The SPC 16 responds to receiving the instruction by storing the content of the instruction in a database 17, which corresponds to database 15 of FIG. 1, and which is being implemented in, or connected to the SPC 16, as indicated in a sixth step T6. An SP indicator may also optionally be provided to the SCP 16 in the instruction at this stage.

In a seventh step, T7, which alternatively can be executed in a different order, as long as it is executed subsequent to step T3, the message 6 is forwarded to the second UE 7.

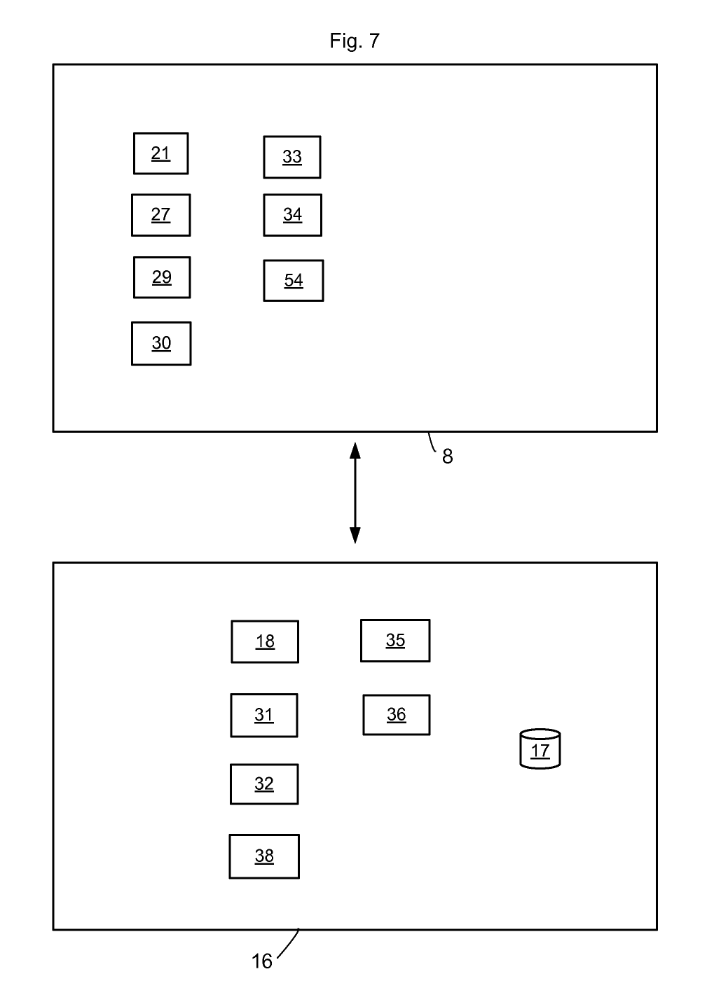

In an optional eights step T8, corresponding to the seventh step S7 shown in FIG. 1, a notifier 18, here comprised in the SCP 16 (see FIG. 7), causes the SCP 16 to send a notification 10 to the proxy server 11, for example as an SS7 message. The notification 10 is thus received by the proxy server 11 and triggering based on the notification 10 can thus be performed by the proxy server 11.

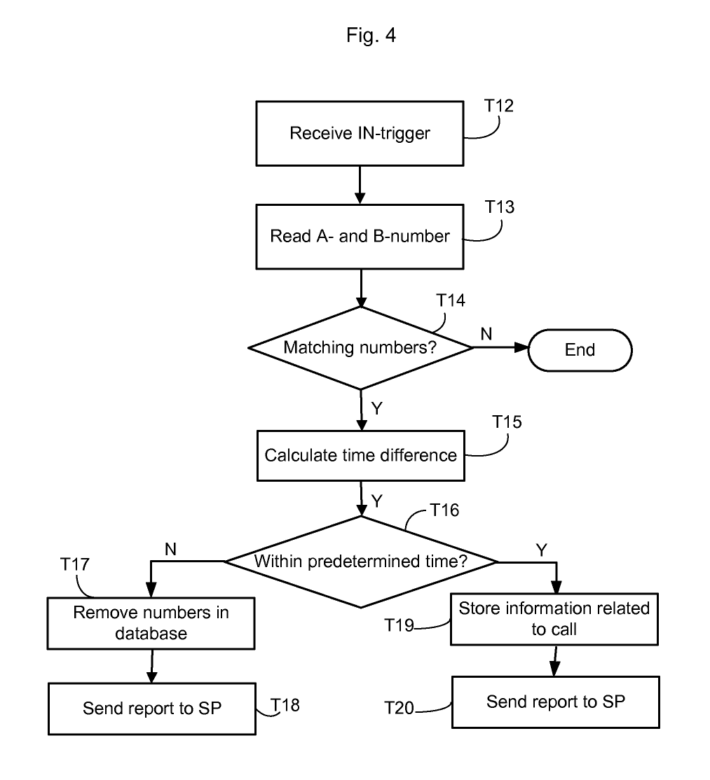

After a time interval has elapsed, the second UE 7 makes a call to the B-number, as indicated in a step T9 in the corresponding way as in the step S8 in the first embodiment, i.e. via the proxy server 11. In a tenth step T10 a trigger message 14 is not sent to the message center 8 as in the first embodiment of FIG. 1, but to the SCP 16, and in an eleventh step T11, corresponding to the tenth step S10 of FIG. 1 the proxy server 11 forwards the call to UE 3 associated with the B-number via e.g. a PBX (Private Branch Exchange (not shown). In a twelfth step T12, illustrated in FIG. 4, together with the subsequent steps of the method which vas initiated in FIG. 1, the SCP 16 receives the trigger message 14, here in the form of an IN-trigger.

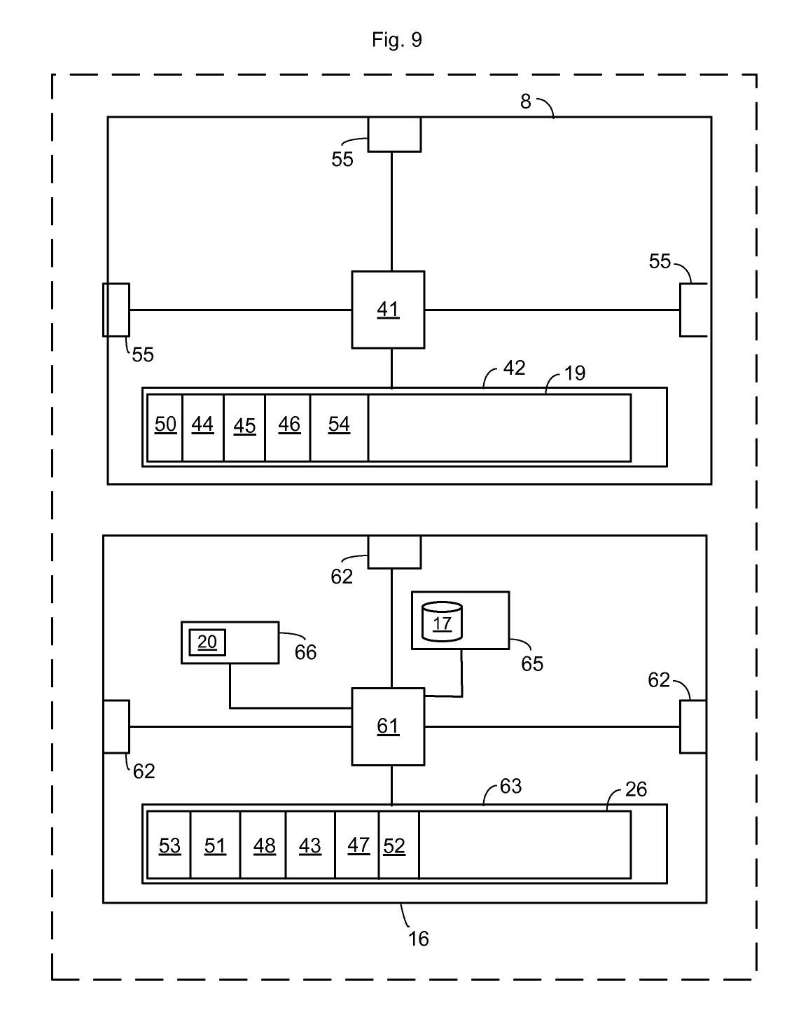

In a thirteenth step T13 a second application 26 (see FIG. 9), i.e. an IN application in the form of a computer program installed and run by the SCP 16 causes the SCP 16 to read the A-number and the B-number in the trigger message 14.

In a fourteenth step T14, the second application 26 also causes the SCP 16 to compare the number-pair, i.e. the A-number and the B-number, retrieved in the trigger message 14, with number-pairs already stored in the database 17, but which in the present embodiment is arranged within, or in connection with, the SCP 16. If there is a matching pair in the database 17, the second application 26 causes the SCP 16 to continue with a fifteenth step T15 where the time difference, t_diff, between the time associated with the reception of the trigger message 14 and the stored time, t_send, associated with the A- and B-number pair in the database 17 is calculated.

In a sixteenth step T16, the SCP 16 compares the time difference, t_diff, with the at least one predetermined time value 20. Just like in the first embodiment disclosed in conjunction with FIG. 2 there is here, for exemplifying purposes, only one time value 20 defined. If the time difference, t_diff, is above time value 20, the call is being deemed as not being associated with the ad. In such a case the SCP 16 may just end the processing associated with the trigger message 14. However, just like in the embodiment shown in FIG. 2, if it is found in the sixteenth step T16 that the time difference, t_diff, is larger than the time value 20, then the second application causes the SCP 16 to, in a seventeenth step T17, remove the record comprising the number-pair and the associated time, t_send, in the database 16 in order to avoid the steps T15 and T16 in the future for the same number-pair when sent from the message center 8 to the SCP 16, at least until the same number-pair and a new time associated with the forwarding of a new reply message with the B-number is sent to the second UE 7. In an optional eighteenth step, T18, a report may be sent to the message server 8, indicating that the respective record has been removed from the database 17.

If the answer is ‘yes’ in the sixteenth step T16, i.e. time difference, t_diff, is smaller than the time value 20, the call is considered as being an action initiated by the ad having been shown to a user of the second UE 7. Therefore, in a ninteenth step T19, the SCP 16 stores at least the A-number, B-number and an indication that a ‘successful’ call has been made. As should be obvious from the description above in conjunction with FIGS. 1 and 2, also other information retrieved by the SCP 16 in cooperation with the proxy server 11, such as the time associated with when the call was made and optionally also an indication of the length of the call (call_length) may be stored in the same time, and in a twentieth step T20, a report, containing at least some of the stored information may be sent to SP 4.

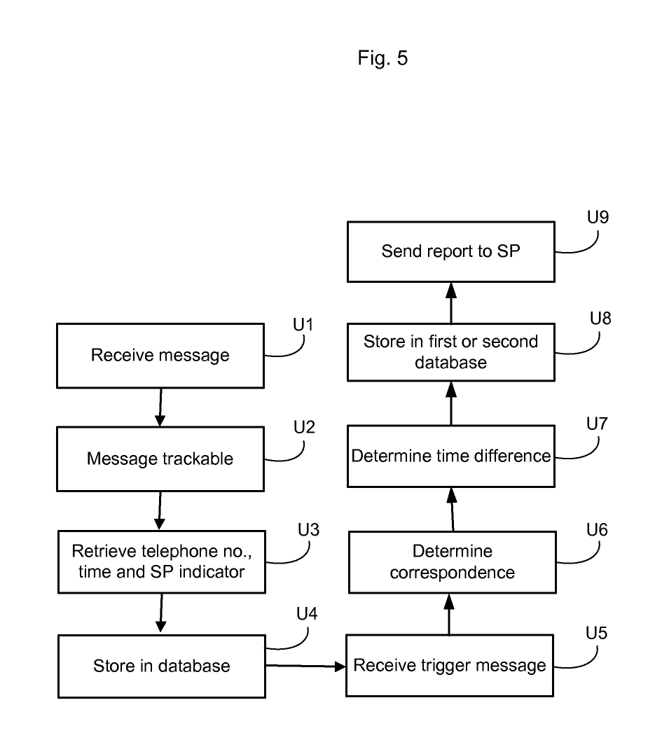

Having described two embodiments together with several specific alternatives within these two embodiments, a method common to these both embodiments of the call-tracking system now will be described in conjunction with FIGS. 5-7. The method can in other words be performed in an embodiment where the call tracking system is a message center 8 alone, or a message center 8 operable in combination with a SCP 16.

In a first step U1 of FIG. 5, first receiving means 29 (see FIGS. 6 and 7) of the message center 8 enables the message center 8 to receive a message 6 from the SP server 5.

In a second step U2, first determining means 33 causes the message center 8 to determine whether a received message is a trackable message 6. This step corresponds to step S4 and T4 above. In the present case it is assumed that the received message is a trackable message.

In a third step U3, which naturally may be performed before, ‘simultaneously’ or after step U2, retrieving means 30 of the message center 8 retrieves the A-number, the B-number, the time, t_send, associated with the forwarding of the message 6 to the second UE 7, as well as the SP indicator from the message 6. Optionally also the ad identity, ad_id, is retrieved by the retrieving means 30 from the message 6.

In a fourth step U4, the parameters/data retrieved by the retrieving means 30 in the third step U3 is stored associated with each other with the help of storing means 31 comprised in the message center 8 or in the SCP 16. If the call-tracking system comprises an SCP 16, instruction means 21 of message center 8 (see FIG. 9) instructs the SCP 16 to continue execution of the call-tracking method. As stated above, the parameters can be stored in the database 15 arranged within or in connection with the message center 8, as indicated in FIG. 1, or in the database 17 arranged within or in connection with the SPC 16, as indicated in FIG. 3. Optionally also the ad identity is stored associated with the other parameters by the storing means 31.

In a fifth step U5, a second receiving means 32 implemented in the message center 8 or the SCP 16, receives 10 a trigger message 14 from the proxy server 11. This step corresponds to step S9 and step T10 respectively, and the second receiving means 32 is accordingly comprised in the message center 8 in the embodiment of FIG. 6 and in the SCP 16 in the embodiment of FIG. 7. It is of course to be understood that prior to receiving a trigger message 14, the message has been forwarded to the second UE 7 via forwarding means 34.

In a sixth step U6, a second determining means 35 determines whether two telephone numbers comprised in the trigger message 14 correspond to the stored A-number and the B-number. In the embodiment of FIG. 6, the second determining means 35 is comprised in message center 8 and the A-number and B-number are stored in database 15. In the embodiment of FIG. 7 the second determining means 35 is instead comprised in the SCP 16, and here the A-number and B-number are stored in database 17, also comprised within, or connected to, the SCP 16. This step corresponds to step S15 and T16 respectively.

In a seventh step U7, the second determining means 35 determines whether or not the call has been made within a predetermined time, e.g. within a time determined by the time value 20 or a predetermined time interval, t_diff from the forwarding of the message 6 from the message center 8 to the second UE 7, if the telephone numbers in the trigger message 14 correspond to a stored A-number/B-number pair. The second determining means 35 is comprised in the message center 8 in the embodiment of FIG. 6, but comprised in the SCP 16 in the embodiment of FIG. 7. The determination performed by the second determining means 35 may be done as mentioned in steps S13-S15 and T14-T16, respectively.

In an eights step U8, a call indicator 36 comprised in the message center 8 according the embodiment of FIG. 1 or in the SCP 16 in the embodiment of FIG. 3, stores information related to the call in the database 14 or 17, respectively, if the call has been made within the predetermined time interval, t_diff. The call indicator 36 may optionally store the ad identity, ad_id, together with the additional information related to the call, i.e. the A-number, B-number, the SP indicator and the time, t_send, associated with the forwarding of the message, and optionally also together with an indicator (call_length) of the length of the telephone call.

In an optional ninth step U9, a report generator 38 comprised in the message center 8 in the first embodiment or in the SCP 16 in the second embodiment, sends a report with call related information to the SP in a ninth step U9.

FIG. 8 schematically shows one example of an embodiment of a message center 8 where the means/units mentioned in conjunction with FIG. 6 are implemented as a first processor 41, e.g. a microprocessor, and a message center computer program 19, adapted to be run by a first processor 41. The message center computer program 19 is here stored on a first computer program product 42 in the form of a first memory comprised in the message center 8. The message center computer program 19 here comprises computer program modules corresponding to the means/units disclosed in FIG. 6, so that the computer program modules when run by the first processor 41 provides the means/units disclosed in conjunction with FIG. 6. In other words, the message center computer program 19 comprises a report generating module 43, a first retrieving module 44, a sending module 45, a first receiving module 46, a storing module 47, a call indicator module 48, a first determining module 50, a second determining module 51, a notification module 52, and a second receiving module 53. The first computer program product can here be a non-volatile memory in the form of a hard disk, a flash memory, a ROM (Read-only memory), a non-volatile RAM, a Compact Disc or a DVD, but it may of course be a volatile RAM wherein the message center computer program 19 have been loaded for execution by the first processor 41.

The message center 8 here also of course comprises input/output ports/circuits 55 for wired or wireless communication with the SCP 16, the SP server 5 and the UE:s 3,7 via a telecommunications network. Examples of such input/output ports are a typical wired Ethernet connector and an optical connector and an example of a circuit for wireless communication is an IEEE 802.11 compatible transceiving circuit. Furthermore, the message center 8 also comprises a second memory 56 for storing the database 15.

The time value or time intervals, t_diff, used in step S15 above may of course be stored as a part of the message center computer program 19, or as separate data in the first memory, but may optionally be comprised in another memory in order to be more easily edited. The time value/time intervals therefore are here illustrated as being stored in a third memory 58, which may be e.g. a flash memory, EEPROM (Electrically Erasable Programmable ROM) or a RAM.

FIG. 9 correspondingly discloses an example of the call tracking system in the form of the message center 8 connected to the SCP 16, as shown in FIG. 7, where the means disclosed in FIG. 7 are implemented with the help of computer programs and processors in FIG. 9. The message center computer program 19 here comprises a retrieving module 44, a sending module 45, a first receiving module 46, a first determining module 50 and an instruction module 54, which corresponds to the retrieving means 30, the forwarding means 34, the first receiving means 29, the first determining means 33 and the instruction means 21.

The SCP 16 comprises a second processor 61, e.g. a microprocessor, connected to input/output ports/circuits 62 for communication with the proxy server 11 and the message center 8. The second processor 61 is also connected to a second computer program product 63 in the form of a fourth memory. A second application 26, here in the form of an IN application, comprises a report generating module 43, a storing module 47, a second receiving module 53, a notification module 52, a second determining module 51 and a call indicator module 48, which modules correspond to report generator 38, the storing means 31, the second receiving means 32, the notification means 18, the second determining means 35 and the call indicator 36, respectively and which when run on the second processor 61 realize the means/units disclosed in FIG. 7. The second computer program product 63 can here be a non-volatile memory in the form of a hard disk, a flash memory, a ROM (Read-only memory), a non-volatile RAM, a Compact Disc or a DVD, but may of course be a volatile RAM when the second application 26 is run by the second processor 61. A fifth memory 56 here comprises the database 17, but the database 17 may of course be stored in a different way as explained above.

As should be readily understood by the skilled person, each one of the means/units mentioned above in conjunction with FIG. 6-9, such as e.g. the report generator 38, the storing means 31, the retrieving means 30, the first receiving means 29, the instructing means 54, the second receiving means 39, the call indicator 36, the message generator 40, the first determining means 33, the second determining means 35, the notifier 18 and the second receiving means 32, can be implemented in the call tracking system as special purpose hardware circuits such as ASICs (Application Specific integrated Circuits) or as a combination of at least one computer program and at least one processor in the message center 8 and, in the case of the embodiment shown in FIG. 7, the SCP 16.

FIG. 10 schematically illustrates an embodiment of the SP server 5, here comprising message means 67 which enables the SP server 5 to create and send a message to the call-tracking system, which message comprises an ad with at least one B-number and a header 12. The message means 67 may be also be configured to insert additional information, such as e.g. an indicator, indicating that the message is trackable, into an information header 9. Optionally the message means 67 is adapted to also add a second header 11 with the ad identity, ad_id, into the message 6. In order to be able to store ad information, the SP server typically also comprises storing means 68.

As should be readily understood by the skilled person, the message means 67, and the report requesting means 22 can be implemented in the SP server 5 as special purpose hardware circuits such as ASICs (Application Specific integrated Circuits) or as a combination of at least one computer program and at least one processor in the SP server 5. FIG. 11 schematically shows one example of an embodiment of the SP server 5 where the message means 67 and the report requesting means 22 are implemented as a third processor 70, e.g. a microprocessor, in combination with a SP server computer program 71 installed on a third computer program product 72 in the form of a fourth memory in the SP server 4. The SP server computer program 71 comprises modules known to a person skilled in the art as being a part of a typical SP server software, but it also comprises a message module 73, and an optional report requesting module 75, which modules correspond to the message means 67, and the report requesting means 22 respectively and which in combination with the third processor 70, i.e. when the SP server computer program 71 is run by the third processor 70 realizes the means illustrated in FIG. 10. It shall also be understood that the report requesting module 75 may in an alternative embodiment be a separate computer program stored on the fourth memory or another memory comprised in the SP server 4. A second database 69 is illustrated as being comprised in a fifth memory 76. The computer program 71 typically also comprises a storing module 74 which enables ad information to be stored in the second database 69. As is commonly known for SP servers, the SP server 5 naturally also comprises input/output ports/circuits 77 for wired or wireless communication with the call-tracking system and other computers. An example of such an input/output port is an Ethernet connector and an example of a circuit for wireless communication is an IEEE 802.11 transceiver circuit, but it may also be telecommunications transceiver circuit such as an LTE (Long Term Evolution) communication circuit.

1. A method performed by a call-tracking system, the method comprising:
receiving, from a service provider a message associated with a first permanent telephone number of a first user equipment addressed to a second user equipment associated with a second telephone number, the message comprising an advertisement, the first telephone number, the second telephone number and a service provider indicator, identifying the service provider;
determining whether the message is a message that is trackable by the call-tracking system;
storing, associated with each other in a database, the first telephone number, the second telephone number, a time associate with the transmission of the message from the call-tracking system to the second user equipment, and the service provider indicator, in response to determining that the message is a trackable message;
forwarding the message to the second user equipment;
receiving, from a proxy server, a trigger message comprising the second telephone number and the first telephone number, the trigger message indicating the initiation of a call originating from the second telephone number and terminating at the first telephone number, and
determining whether the two telephone numbers of the trigger message correspond to the telephone numbers stored associated with each other in the database, and whether the call has been made within a predetermined time interval, indicating the time duration that has elapsed from the forwarding of the message from the call-tracking system to the second user equipment to the making of the call,
wherein the call is considered to be associated with the message in response to two numbers of the trigger message corresponding to the telephone numbers stored associated with each other in the database and further in response to the call having been made within the predetermined time interval.

2. A method according to claim 1, further comprising storing advertisement information indicative of the call originating at the second telephone number and terminating at the first telephone number in response to the two number pairs corresponding to each other and in response to the call being considered to be associated with the message.

3. A method according to claim 1, wherein the storing of advertisement information comprises storing an indication of the length of the call.

4. A method according to claim 1, further comprising transmitting at least some of the advertisement information to the service provider.

5. A method according to claim 1, wherein the first telephone number is provided via an Application Programming Interface.

6. A method according to claim 5, wherein the Application Programming Interface is at least one of a short message peer to peer Application Programming Interface and an MM7 Application Programming Interface.

7. A method according to claim 1, wherein the determining whether the message is a trackable message comprises:
interrogating an information header of the message, and
determining that the message is a trackable message in response to the information header containing such an indication.

8. A method according to claim 1, wherein the message comprises an advertisement identity, identifying the advertisement and wherein, during the storing, the advertisement identity is stored in the database together with the associated second telephone number, the first telephone number, the time of transmission of the message from the call-tracking system to the second user equipment, and the service provider indicator.

9. A method according to claim 1, wherein the call-tracking system comprises at least a short message service center and the message is an SMS message.

10. A method according to claim 1, wherein the call-tracking system comprises at least a multimedia message service center and the message is an MMS message.

11. A method according to claim 9, wherein the call-tracking system comprises a Service Control Point.

12. A method according to claim 1, wherein the trigger message is an Intelligent Network trigger.

13. A method according to claim 1, wherein the service provider indicator is a Uniform Resource Locator associated with the service provider.

14. A call-tracking system, comprising:
first receiving means configured to receive, from a service provider, a message associated with a first permanent telephone number of a first user equipment addressed to a second user equipment associated with a second telephone number, the message comprising an advertisement, the first telephone number, the second telephone number and a service provider indicator identifying the service provider;
first determining means configured to determine whether the message is a message that is trackable by the call-tracking system;
storing means configured to store, associated with each other in a database, the first telephone number, the second telephone number, a time associate with the transmission of the message from the call-tracking system to the second user equipment, and the service provider indicator, in response to determining that the message is a trackable message;
forwarding means configured to forward the message to the second user equipment;
second receiving means configured to receive, from a proxy server a trigger message comprising the second telephone number and the first telephone number, the trigger message indicating the initiation of a call originating from the second telephone number and terminating at the first telephone number, and
second determining means configured to determine whether the two telephone numbers of the trigger message correspond to the telephone numbers stored associated with each other in the database, and, whether the call has been made within a predetermined time difference, indicating the time duration that has elapsed from the forwarding of the message from the call-tracking system to the second user equipment to the making of the call, such that the call is considered to be associated with the message in response to the two telephone numbers of the trigger message corresponding to the telephone numbers stored associated with each other in the database and further in response to the call having been made within time interval.

15. A call-tracking system according to claim 14, further comprising a call indicator configured to store advertisement information indicative of the call originating at the A-number and terminating at the B-number in response to the two number pairs corresponding to each other and in response to the call being considered to be associated with the message.

16. A call-tracking system according to claim 14, wherein the call indicator is configured to store, as at least part of the advertisement information, an indication of the length of the call.

17. A call tracking system according to claim 14, further comprising a report generator configured to transmit at least a part of the advertisement information to the service provider.

18. A call-tracking system according to claim 17, wherein the first receiving means is configured to identify the first telephone number when provided via an Application Programming Interface.

19. A call-tracking system according to claim 14, wherein the first determining means is configured to:
interrogate an information header of the message, and
determine that the message is a trackable message in response to the information header containing such an indication.

20. A call-tracking system according to claim 14, wherein the call-tracking comprises a short message service center.

21. A call-tracking system according to claim 14, wherein the call-tracking system comprises a Multimedia message service center.

22. A call-tracking system according to claim 20, wherein the call-tracking system comprises a Service Control Point.

23. A call-tracking system according to claim 22, wherein the second determining means is arranged in the Service Control Point.

24. A call-tracking system according to claim 22, wherein the storing means and/or the call indicator is arranged in the Service Control Point.

25. A service provider server adapted to interact with a call-tracking system according to claim 14, comprising:
message means configured to create and send a message to the call tracking system, wherein the message means is configured to insert into the message a header indicating that a message is a traceable message.

26. A call-tracking system computer program, comprising computer readable code which when run by a node of the call tracking system causes the node to:
receive, from a service provider a message associated with a first permanent telephone number of a first user equipment addressed to a second user equipment associated with a second telephone number, the message comprising an advertisement, the first telephone number, the second telephone number and a service provider indicator identifying the service provider;
determine whether the message is a message that is trackable by the call-tracking system;
store, associated with each other in a database, the first telephone number, the second telephone number, a time associate with the transmission of the message from the call tracking system to the second user equipment, and the service provider indicator, in response to determining that the message is a trackable message;
forward the message to the second user equipment;
receive, from a proxy server, a trigger message comprising the second telephone number and the first telephone number, the trigger message indicating the initiation of a call originating from the second telephone number and terminating at the first telephone number, and
determine whether the two telephone numbers of the trigger message correspond to the telephone numbers stored associated with each other in the database, and whether the call has been made within a predetermined time interval indicating the time duration that has elapsed from the forwarding of the message from call-tracking system,
wherein the call is considered to be associated with the message in response to the two telephone numbers of the trigger message corresponding to the telephone numbers stored associated with each other in the database and further in response to the call having been made within the predetermined time interval.

27. A call-tracking system computer program according to claim 26, wherein when run on the node of the call tracking system the computer readable code also causes the node to store advertisement information indicative of the call originating at the A-number and terminating at the B-number in response to the two number pairs corresponding and in response to the call being considered to be associated with the message.

28. A call-tracking system computer program according to claim 27, further comprising computer readable code which when run on the node of the call tracking system causes the node to transmit the advertisement information to the service provider.

29. A call-tracking system computer program according to claim 27, comprising computer readable code which when run on the node of the call tracking system causes the node to store as advertisement information an indication of the length of the call.

30. A call-tracking system computer program according to claim 26, comprising computer readable code which when run on the node of the call tracking system causes the node to:
interrogate an information header of the message, and to
determine that the message is a trackable message in response to the information header containing such an indication.

31. A call-tracking system computer program according to claim 26 comprising computer readable code which when run on the node of the call tracking system causes the node to store an advertisement identity, identifying the advertisement, in the database together with the associated the first telephone number, the second telephone number, the time associated with transmission of the message from the call tracking system to the second user equipment, and the service provider indicator.

32. A computer program product comprising the call tracking system computer program according to claim 26, the call tracking system computer program being stored on a computer readable means.
